(19) United States
(12) Patent Application Publication
(10) Pub. No.: US 2003/0172696 A1
(43) Pub. Date: Sep. 18, 2003

(54) Key identification system

(76) Inventor: Michael David Regina, Drexel Hill, PA (US)

Correspondence Address: Michael D. Regina, 710 Clarendon Road, Drexel Hill, PA, 19026, US

(21) Appl. No.: 10/382,785

(22) Filed: Mar. 6, 2003

Related U.S. Application Data
(60) Provisional application No. 60/362,844, filed on Mar. 11, 2002.

(51) Int. Cl. E05B 19/04; E05B 19/24

(52) U.S. Cl. 70/460; 70/408

(57) ABSTRACT

The Key Identification System enables a key to be quickly and easily related to a object/structure/item. It accomplishes this by having the key manufactured in a way to have the head/bow take on the appearance/shape of the object/structure/item that the key will be opening. It will NOT have the appearance/shape of a door/lid or lock because the door/lid and lock are not a distinguishable part of the object/structure/item that the key is used for. So therefore a key that opens the front door of a house is in the appearance/shape of a house, the key that opens a car is in the appearance/shape of a car and so on.

Unlike other “systems” this is not added onto an already manufactured key, but is manufactured as one in the same as the key and actually is the key itself.

### CROSS REFERENCE TO RELATED APPLICATIONS

Not Applicable

### STATEMENT REGARDING FEDEARLLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

The present invention pertains to a system for identification of keys and their corresponding object/structure/item(s). More specifically the present invention relates to a system that is actually manufactured as part of the key as to give the key head/bow a specific appearance/shape, so that the key may be identified and related to a particular object/structure/item. The appearance/shape of the head/bow is of the object/structure/item that the key is opening and not the door/lid(s) and lock(s). So a key for a house would be in the shape/appearance of a house and so forth.

### BRIEF SUMMARY OF THE INVENTION

This system is an attempt to solve a problem that modern man suffers from and it is a problem that is not specific to a particular country, sex or race. The problem that I am speaking of is that of keys and particularly the vast number of keys modern man carries around and his inability to distinguish which of his keys are used for which of his possession(s). Many of today's keys look very similar and it is difficult to distinguish one key from another. This system is extremely simple and it solves numerous problems. One problem that is solved is obviously the inability to relate keys to their specific object/structure/item. Another problem that is solved is the incapability of man to see in the dark and thus see which key he is looking for. The solution is in the shape/appearance of the key head/bow, in that, it enables the key one is searching for to be discerned by feel alone. And a final, though minor, problem that is solved is the fact that normal key head/bows are small and do not offer much leverage to the young or elderly. Since the system will most likely increase the surface area of a key head/bow, gaining leverage in turning the key is much easier.

### BRIEF DESCRIPTION OF THE SEVERAL VIEWS OF THE DRAWING

FIG. 1 is a frontal elevational view of a first embodiment of a key bow/head showing my new identification system, the rear being a mirror image of that shown;

FIG. 2 is a top plan view of the embodiment shown in FIG. 1;

FIG. 20 is a bottom plan view of the embodiment shown in FIG. 1;

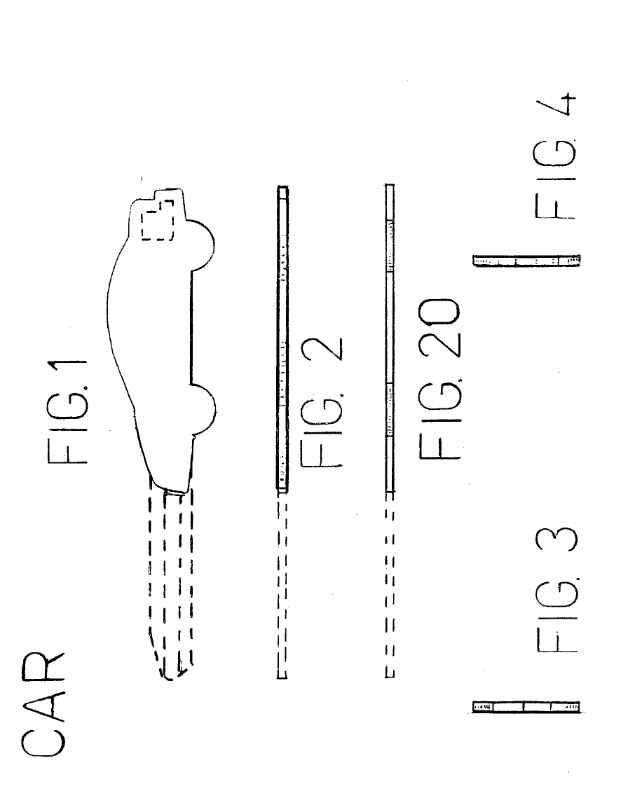

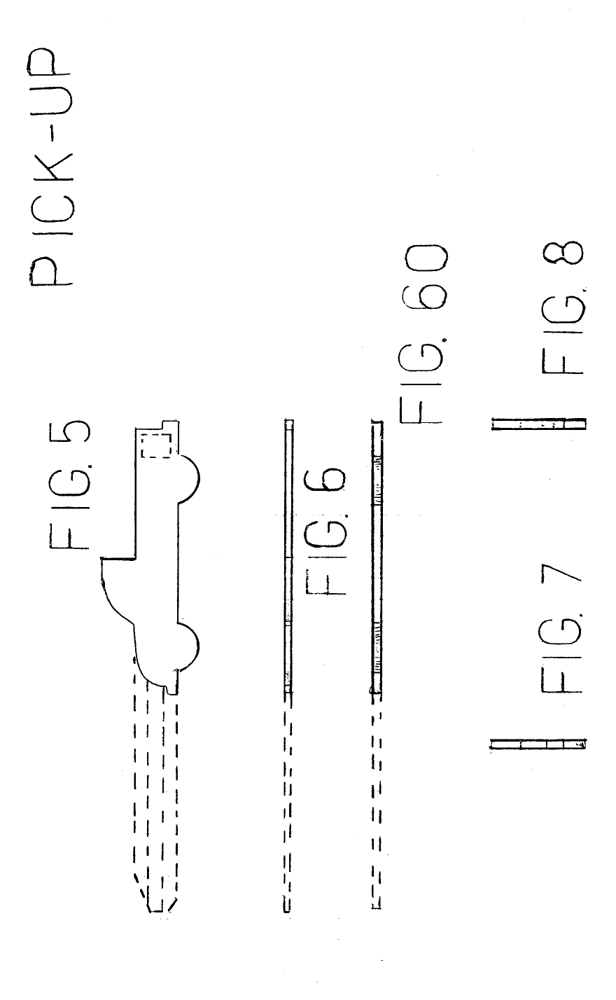

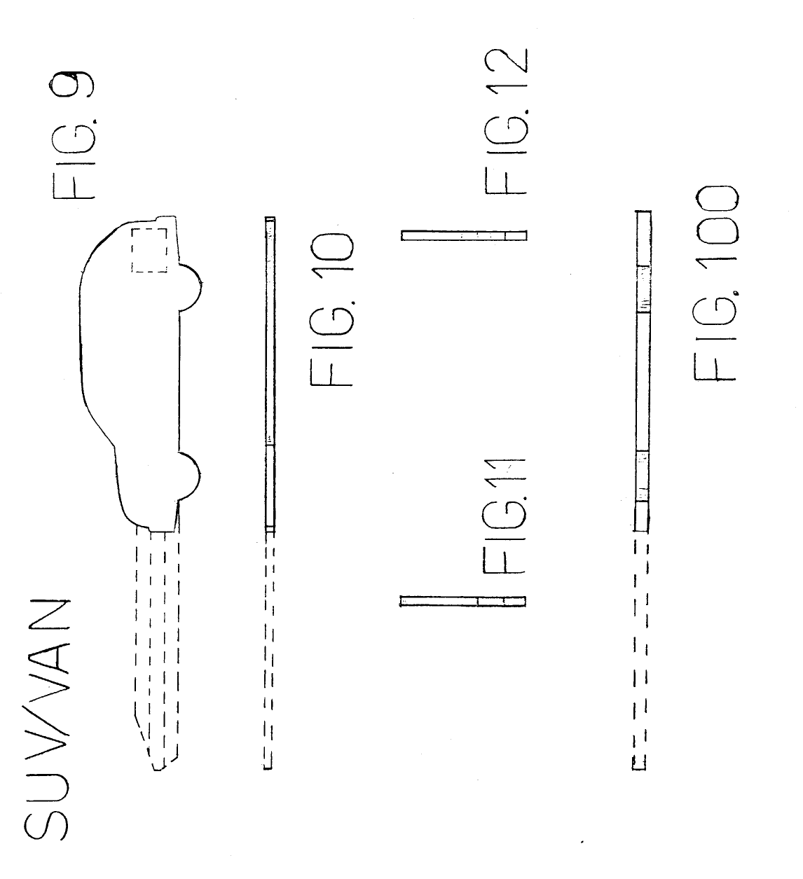

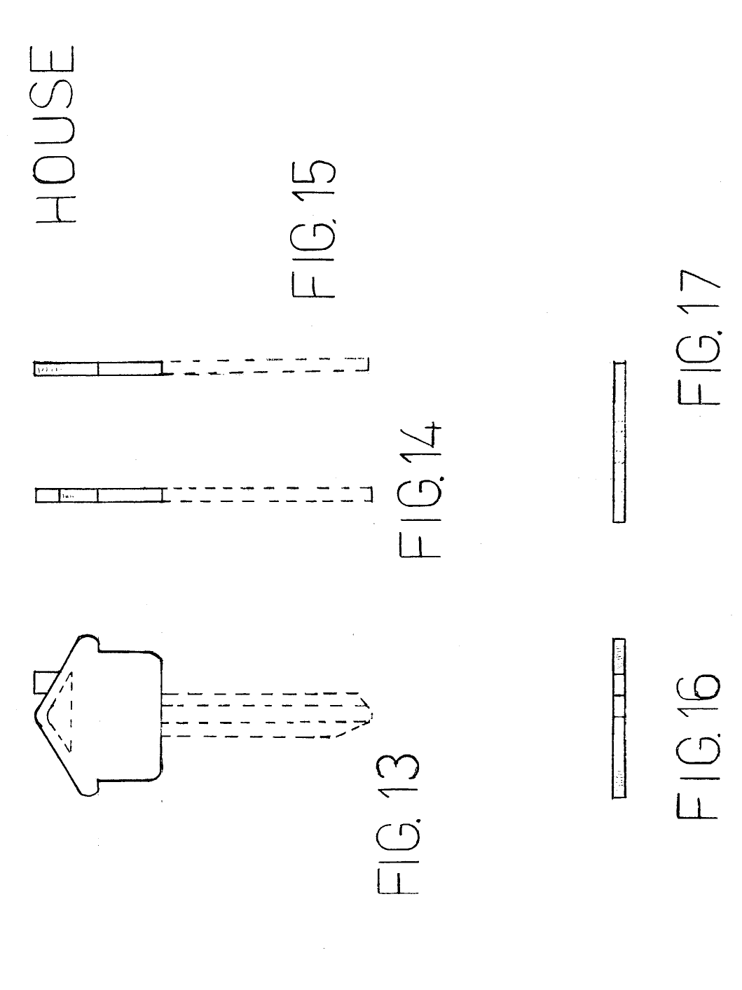

FIG. 3 is a left side elevational of the embodiment shown in FIG. 1;

FIG. 4 is a right side elevational of the embodiment shown in FIG. 1;

FIG. 5 is a frontal elevational view of a second embodiment of a key bow/head showing my new identification system, the rear being a mirror image of that shown;

FIG. 6 is a top plan view of the embodiment shown in FIG. 5;

FIG. 60 is a bottom plan view of the embodiment shown in FIG. 5;

FIG. 7 is a left side elevational of the embodiment shown in FIG. 5;

FIG. 8 is a right side elevational of the embodiment shown in FIG. 5;

FIG. 9 is a frontal elevational view of a third embodiment of a key bow/head showing my new identification system, the rear being a mirror image of that shown;

FIG. 10 is a top plan view of the embodiment shown in FIG. 9;

FIG. 100 is a bottom plan view of the embodiment shown in FIG. 9;

FIG. 11 is a left side elevational of the embodiment shown in FIG. 9;

FIG. 12 is a right side elevational of the embodiment shown in FIG. 9;

FIG. 13 is a frontal elevational view of a fourth embodiment of a key bow/head showing my new identification system, the rear being a mirror image of that shown;

FIG. 14 is a top plan view of the embodiment shown in FIG. 13;

FIG. 15 is a bottom plan view of the embodiment shown in FIG. 13;

FIG. 16 is a left side elevational of the embodiment shown in FIG. 13;

FIG. 17 is a right side elevational of the embodiment shown in FIG. 13;

The broken line disclosure of the key shank is for illustrative purposes only and forms not part of the claimed identification system. The drawings are not drawn to scale or exact proportion.

### DETAILED DESCRIPTION OF THE INVENTION

An identification system, which enables keys to be associated to the objects that the key and corresponding lock opens. It is assumed that all locks obviously open some sort of door or lid, but the object in reference to is the actual object that the door is an integral part of. The actual system is manufactured into the key. The system requires that the key blank be manufactured so the head/bow has the shape/appearance of the object the key, lock, and door are made to open, as seen in FIGS. 1, 5, 9, and 13. Manufacturers make keys to correspond to certain types of locks, whether these are locks used in doors for houses, cars, or whatever. Therefore the manufacturer knows which key blanks are associated with which type of lock and hence the object to which lock is opening. So key blanks manufactured for house locks will have a head/bow that has the shape/appearance of a house as exampled in FIG. 13. A key made for an automobile will have a head/bow in the shape/appearance of an automobile, and so forth of which some examples can be examined in FIGS. 1, 5, and 9. The actual means of manufacturing the key blank is inconsequential to the system and can be decided by the manufacturer itself. The system works regardless of the actual method used to create the key blank, whether it is molding, cutting, pressing, et cetera. The exact materials used in the manufacturing process are also independent of the identification system, though it is assumed that some type of metalloid material is used, though this is also up to the manufacturer. The end result of the manufacturing process should yield a key blank with a head/bow that has the shape/appearance of the object/structure/item that the door/lid(s) and lock(s) are opening. The exceptions to this are the key blanks that are made to open locks that are external to and not an integral part of the object, i.e. padlocks. The locks are portable and can be used on any type of object, so therefore the key head/bow will have the shape/appearance of a padlock and not the object to which the padlock is locking. So the identification requires that the head/bow of the key blank be manufactured to have the shape/appearance of the object/structure/item the corresponding door/lid(s)and lock(s) are opening. The major difference between this system and other key identification systems is that other systems require the so-called system to be installed after the key has already been manufactured; where as the described system is manufactured directly into the key and therefore the key is the system. Please see the attached figures of some examples for a better understanding of the identification system.

What I claim as my invention is:

1.) An identification system comprising of a key, which the head/bow is manufactured in the shape/appearance of the object/structure/item it is opening.

2.) The shape/appearance of the key head/bow in claim 1 refers to the object/structure/item that the door/lid(s) and lock(s) are a part of and open and not the actual door/lid(s) and lock(s) themselves.

3.) The system in claim 1 is one in the same as the key mentioned in claim 1.
a.) The system in claim 1 is one in the same as the head/bow mentioned in claim 1.

4.) The exception to claim 2 is when the system is identifying a lock that is not a permanent part of the object/structure/item. This meaning a padlock or a type of lock that is easily transportable between object/structure/item(s).

5.) The system in claim 1 is manufactured as the actual key and it is particularly the head/bow portion of the key as mentioned in claim 3.

6.) The method(s) of manufacturing mentioned in claim 5 is completely irrelevant and independent of the system and shall be decided by the manufacturer.

7.) The material(s) used in the manufacturing of the system in claim 5 is also completely irrelevant and independent to the operation of the system and shall be decided by the manufacturer.

8.) The system in claim 2 can be utilized on an object/structure/item that include a door/lid(s) and lock(s) whether these door/lid(s) and lock(s) be a permanent, integral part of the structure or not.

9.) It is possible for the original door/lid(s) and lock(s) in claim 8 to be replaced or removed, but this does not change the operation or relevancy of the system to that object/structure/item.

10.) The system in claim 2 is in the shape/appearance of the object/structure/item and not of a door/lid(s) and lock(s) because the after mentioned are not a specific or distinguishable part of the object/structure/item.

11.) The system in claim 1 differs from other so-called “Key Identification Systems” in that it is not added to the key after manufacturing and is actually the key and key head/bow and is manufactured as such.
